(19) United States
(12) Patent Application Publication
(10) Pub. No.: US 2026/0116320 A1
(43) Pub. Date: Apr. 30, 2026

(54) SEALED DECK TOP CHARGING

(71) Applicant: Toyota Motor Engineering & Manufacturing North America, Inc., Plano, TX (US)

(72) Inventors: Scott P. Robison, Saline, MI (US); Scott L. Frederick, Brighton, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/932,418

(22) Filed: Oct. 30, 2024

(51) Int. Cl. B60R 16/03; B60R 13/06; B62D 33/023; H02J 50/10

(52) U.S. Cl. CPC B60R 16/03; B60R 13/06; B62D 33/023; H02J 50/10

(57) ABSTRACT

Methods, systems, and apparatus for a covering equipped with a charging surface for a wall of a vehicle cargo bed. The covering includes a first portion structured to be attached to a top portion of the wall, the first portion having a first surface including a charging area configured to receive a rechargeable device and a second surface configured to face the top portion of the wall when the first portion is attached to the top portion of the wall. A charging unit can be disposed between the top portion of the wall and the second surface directly beneath the charging area for charging the rechargeable device in response to the rechargeable device being placed on the charging area of the first surface.

### BACKGROUND

### Field

The present disclosure relates to protective coverings which may be attached to top portions of a sidewall or tailgate defining a vehicle cargo bed.

### Description of the Related Art

Owners of vehicles (for example, pickup trucks) having cargo beds may use their vehicles for recreational purposes (such as camping, tailgating, or picnics), for construction or renovation projects, or for a variety of other purposes. Such activities may involve a user standing and working outside the cargo bed. Such activities may involve items such as multiple tools and other implements or devices. Locations for positioning items not currently being used may be limited to the ground or the cargo bed. Storing items in the cargo bed may require the user to constantly reach into the cargo bed. However, depending on the position and orientation of the vehicle with respect to the user and the contents of the cargo bed, it may be inconvenient for the user to constantly reach into the cargo bed.

To charge a phone for example, users typically must go inside their truck cab to use wireless or wired charging. Another option is to use an outlet located in the cargo bed of the vehicle. This means the user will have to tote a charger around and risk damage in weather and/or in transit.

Accordingly, it is desirable to provide systems, methods, and techniques for convenient charging of personal items near the cargo bed of the vehicle.

### SUMMARY

One aspect of the subject matter described in this disclosure may be embodied in a covering for a wall of a vehicle cargo bed. The covering can include a first portion structured to be attached to a top portion of the wall, the first portion having a first surface including a charging area configured to receive a rechargeable device and a second surface configured to face the top portion of the wall when the first portion is attached to the top portion of the wall. The covering can include a second portion rotatably connected to the first portion, the second portion having a first surface, the second portion being rotatable between a first orientation in which the second portion first surface resides directly opposite the first portion first surface and faces in a first direction toward the first portion first surface, and a second orientation in which the second portion first surface faces in a second direction opposite the first direction. The covering can include a charging unit configured to be disposed between the top portion of the wall and the second surface directly beneath the charging area for charging the rechargeable device in response to the rechargeable device being placed on the charging area of the first surface.

In another aspect, the subject matter may be embodied in a vehicle. The vehicle can include a wall defining a portion of a cargo bed and a covering mounted on a top portion of the wall. The covering includes a first portion structured to be attached to the top portion of the wall, the first portion having a first surface including a charging area configured to receive a rechargeable device and a second surface configured to face the top portion of the wall when the first portion is attached to the top portion of the wall. The covering further includes a charging unit configured to be disposed between the top portion of the wall and the second surface directly beneath the charging area for charging the rechargeable device in response to the rechargeable device being placed on the charging area of the first surface. In various aspects, the covering can further include a second portion rotatably connected to the first portion, the second portion having a first surface, the second portion being rotatable between a first orientation in which the second portion first surface resides directly opposite the first portion first surface and faces in a first direction toward the first portion first surface, and a second orientation in which the second portion first surface faces in a second direction opposite the first direction.

These and other embodiments may optionally include one or more of the following features.

The charging unit can be a non-contact charger (e.g., an electromagnetic induction charger).

The charging area can include a cavity formed in the first surface.

The charging area can be at least partially delineated by a ridge extending from the first surface.

A cavity can be disposed in the first portion. The cavity is spaced apart from the charging area, and the second portion is configured to cover the cavity in the first orientation.

The covering can further include a seal disposed on the first portion first surface and surrounding the charging area. The seal is configured to stop debris from entering the charging area and the second portion first surface is configured to contact the seal when the second portion is in the first orientation.

The covering can further include a seal extending between and to the first portion second surface and the top portion of the wall and surrounding the charging unit to enclose a charging unit cavity from an ambient environment. The seal is configured to stop debris from contacting the charging unit.

A cooling hole can be disposed in the top portion of the wall and in fluid communication with the charging unit cavity.

The second portion first surface can be structured to be substantially coplanar with the first portion first surface when the second portion is in the second orientation.

The second portion first surface can be flat. The first portion first surface can be flat. The second portion first surface can be structured to be substantially coplanar with the first portion first surface when the second portion is in the second orientation.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 is a schematic perspective view of a portion of a pickup truck including a protective covering equipped with a charging unit and attached to a top surface of each sidewall of the pickup truck cargo bed, according to an aspect of the invention.

FIG. 1A is a schematic cross-sectional view of a covering equipped with a charging unit and attached to a top or uppermost surface of a sidewall of the cargo bed, according to an aspect of the invention.

FIG. 2 is a schematic perspective view of a portion of a pickup truck including a protective covering equipped with a charging unit and attached to a top surface of a sidewall of the pickup truck cargo bed, according to an aspect of the invention.

FIG. 3A and FIG. 3B are schematic top views of the protective covering of FIG. 2 with a covering second portion in a second orientation (e.g., open) and a first orientation (e.g., closed), respectively, according to an aspect of the invention.

FIG. 4 is a schematic cross-sectional view of a covering equipped with a charging unit and attached to a top or uppermost surface of a sidewall of the cargo bed, according to an aspect of the invention.

FIG. 5 is a schematic cross-sectional view of a covering equipped with a charging unit and attached to a top or uppermost surface of a sidewall of the cargo bed, according to an aspect of the invention.

FIG. 6 is a schematic cross-sectional view of a covering equipped with a charging unit and attached to a top or uppermost surface of a sidewall of the cargo bed, according to an aspect of the invention.

### DETAILED DESCRIPTION

Disclosed herein are systems, methods, devices, and/or vehicles for implementing a covering equipped with a charging surface for a wall of a vehicle cargo bed. The covering includes a first portion structured to be attached to a top portion of the wall. The first portion has a first surface including a charging area configured to receive a rechargeable device and a second surface configured to face the top portion of the wall when the first portion is attached to the top portion of the wall. A charging unit can be disposed between the top portion of the wall and the second surface directly beneath the charging area for charging (e.g., via an electromagnetic field) the rechargeable device in response to the rechargeable device being placed on the charging area of the first surface.

Utilizing a charging unit with a cargo bed wall protector (also referred to as a deck top protector) would typically not be desirable because of the small width of the deck top area as well as the area's exposure to weather. Various aspects described herein utilize a weatherstrip on the covering to seal off an area of the deck protector for a charging unit.

Various aspects described herein utilize a plastic cover on the wall of a truck deck to mount a charging unit. The charging unit could be flat for wireless charging or could be an outlet or battery charging port. For a port, a cap or cover can be available to be placed over this port when not in use. The cover may utilize a weatherstrip or other sealing technologies to keep the area from being exposed to any damage. This damage could come from water, dust, impact, or various other sources.

People who are camping, tailgating, or working construction spend a lot of time by truck beds. They need a place to charge their devices with minimal effort. To charge a phone for example, customers must go inside their truck cab to use wireless or wired charging. Their other option is to use one of the auxiliary bed plugs similar to how they might power their tools or other devices. This means they will have to tote a charger around and risk damage in weather and/or in transit. A covering equipped with a charging surface provides a convenient, weatherproof place to charge devices outside of the cab.

Embodiments described herein relate to coverings for a wall of a vehicle (such as a pickup truck, for example) which defines a portion of a vehicle cargo bed. Each covering may include a first portion structured to be attached to a top portion of the wall, and a second portion rotatably connected to the first portion. The first and second portions may have respective first surfaces. The second portion is rotatable between a first orientation in which the second portion first surface resides directly opposite the first portion first surface and faces in a first direction toward the first portion first surface, and a second orientation in which the second portion first surface faces in a second direction opposite the first direction. When the second portion of the covering is in its second orientation, the first portion first surface and the second portion first surface are adjoining and substantially coplanar and may combine to define a surface usable for the placement of objects thereon. This provides a storage surface at a height which is convenient and accessible for a user either inside the cargo bed or standing next to the vehicle.

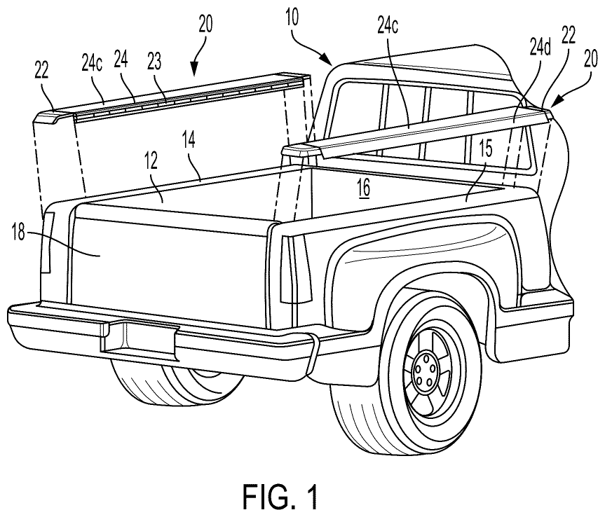

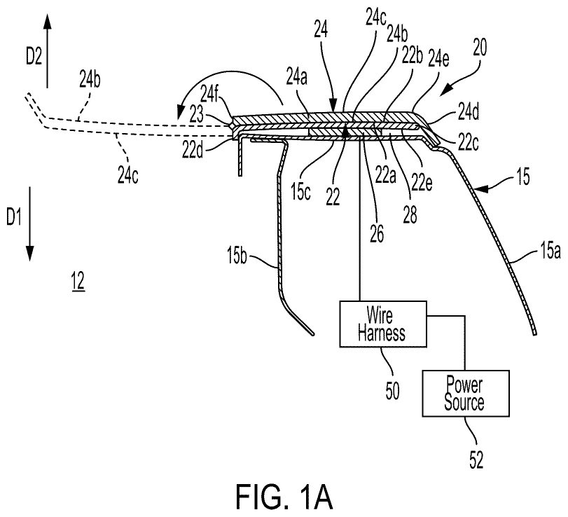

FIGS. 1-6 show various embodiments and possible features of a protective covering or cap for a top portion of a wall defining a portion of a vehicle cargo bed. With reference to the drawings, the vehicle (generally designated by the reference numeral 10) is in the form of a pickup truck, and includes a cargo bed 12 defined by a floor and a plurality of walls surrounding the floor, which may include left and right sidewalls 14 and 15, respectively, a front wall 16, and a tailgate 18. However, embodiments of the covering described herein may be mountable to cargo bed walls of vehicles other than pickup trucks. A covering as described herein may be mountable to a top or uppermost portion of any of the walls 14, 15, 16, and 18, in accordance with various aspects. The vehicle 10 of FIG. 1 shows an aspect of the protective covering attached to the sidewalls 14 and 15 of the truck. However, the covering may be attached to at least any of the sidewalls 14 and 15 and/or the tailgate 18.

FIG. 1A is a schematic cross-sectional view of a covering 20 attached to a top or uppermost surface 15c of a wall 15 of the cargo bed 12. In the example shown, the wall 15 is a sidewall of the bed. However, the covering 20 may alternatively be attached to any of the other walls 14, 16, or 18 shown in FIG. 1. The wall 15 also has an exterior surface 15a extending from a first edge of the top surface 15c along a portion of the vehicle exterior of the cargo bed 12, and an interior surface 15b extending from a second edge of the top surface 15c opposite the first edge. The interior surface 15b extends along the interior of the cargo bed 12.

Referring to FIG. 1A, the covering 20 may include a first portion 22 having a body 22a structured to be attached to the top surface 15c of the wall 15. The first portion body 22a may have a first surface 22b. The first portion body 22a may be attached to the wall 15 using any suitable method, for example, adhesives or mechanical fasteners. The covering 20 may also include a second portion 24 rotatably connected to the first portion 22 at one or more rotatable connections 23. The second portion 24 may have a body 24a including a first surface 24b along one side thereof and a second surface 24c along an opposite side thereof. In one or more arrangements, the second portion first surface 24b is flat, to facilitate the placement of objects thereon according to the needs of a user. A shoulder 24d may extend from a first edge 24e of the second portion 24 at an angle with respect to the second portion first surface 24b. The shoulder 24d may be structured to cover a first edge 22c of the first portion body 22a, as well as a portion of the top surface 15c of the wall 15. If desired, an outer surface of the shoulder 24d may be shaped to closely follow a contour of the exterior wall surface 15a, as seen in FIGS. 1-3.

In one or more arrangements, and as seen in FIG. 1A, the second portion shoulder 24d may form an obtuse angle with the second portion first surface 24b. However, the shoulder 24d may extend from the second portion 24 so as to form a right angle with the second portion first surface 24b or may extend from the second portion first surface 24b at any other desired angle.

The second portion 24 may have a first orientation (shown in solid lines in FIG. 1A) in which the second portion first surface 24b resides directly opposite the first portion first surface 22b and faces in a first direction D1, toward the first portion first surface 22b. A clip, pin, detent, or other securement mechanism (not shown) may be applied to the second portion 24 and/or the first portion 22 if needed, to secure the second portion 24 in the first orientation.

The second portion 24 may also have a second orientation (shown in phantom lines in FIG. 1A) in which the second portion first surface 24b adjoins or resides adjacent the first portion first surface 22b and faces in a second direction D2 opposite the first direction D1. In the example shown in FIG. 1A, when the covering 20 is attached to the wall 15 of the vehicle 10, the direction D1 may be a downward direction while the direction D2 is an upward direction with respect to the vehicle 10. The second portion 24 may be rotatable between the first and second orientations. An edge 22d of the first portion 22 and an edge 24f of the second portion may be structured to abut each other when the second portion 24 is in the second orientation, to help support and maintain the second portion 24 in the second orientation.

In one or more arrangements, the direction D2 may be an upward direction, and the first portion first surface 22b may be structured to face in the direction D2 when the first portion 22 is attached to the wall top surface 15c, and the second portion first surface 24b may be structured to face in the direction D2 when the second portion 24 is in the second orientation. As seen in FIG. 1A, the shoulder 24d may be structured to extend from second portion body 24a in an upward direction D2 when the first portion body 22a is attached to the wall 15 and the second portion 24 is in the second orientation.

Rotatable connections between the first and second portions of the covering 20 may be in any form suitable for the purposes described herein. In one or more arrangements, for example, a hinge utilizing one or more hinge pins such as metal pin(s) may be used. Elements of the covering 20 described herein may be formed from any suitable material or materials. For example, elements of the covering 20 may be molded from suitable polymers and/or metallic materials.

In various aspects, the second portion first surface 24b may be flat, the first portion first surface 22b may be flat, and the first portion first surface 22b and the second portion first surface 24b may be structured to be substantially coplanar when the second portion 24 is in the second orientation. In one or more arrangements, the first portion first surface 22b and the second portion first surface 24b specified herein as being coplanar or substantially coplanar may be coplanar within a tolerance zone of 0.10 inches.

Alternatively, the second portion first surface 24b may be concave with respect to the first portion first surface 22b when the second portion first surface 24b faces the first portion first surface 22b (i.e., when the second portion 24 is in the first orientation). In addition, the first portion first surface 22b may be convex with respect to the second portion first surface 24b when the second portion 24 is in the first orientation. In FIG. 1A, for example, the second portion first surface 24b may be concave with respect to the first portion first surface 22b when the second portion first surface 24b faces the first portion first surface 22b. In addition, the first portion first surface 22b may be convex with respect to the second portion first surface 24b when the second portion is in the first orientation. This configuration may effectively form a “well” or depression along the second portion first surface 24b between the shoulder 24d and the first portion first surface 22b in which objects may be placed and retained, when the second portion 24 is in the second orientation.

The first portion body 22a may have a second surface 22e disposed along a second side thereof opposite the first surface 22b. The first portion second surface 22e can face the uppermost surface 15c of the wall 15 of the cargo bed 12 when the covering 20 is in an installed position. At least a portion of the first portion second surface 22e can be spaced apart from the uppermost surface 15c to accommodate a charging unit 26 therebetween. In this regard, a cavity 28 can be defined between the uppermost surface 15c and the first portion second surface 22e wherein the charging unit 26 resides. The charging unit 26 can be sized and positioned to provide induction charging to a rechargeable device (e.g., a smartphone) that is placed on the first portion first surface 22b.

In various aspects, the charging unit 26 is a non-contact charger (e.g., an electromagnetic induction charger). The charging unit 26 can be configured to receive electric power from an onboard power source (e.g., a vehicle battery) and transmit the power to the rechargeable device in a non-contact manner by electromagnetic induction. In this regard, the covering 20 can perform non-contact charging (induction charging) for charging a rechargeable device (e.g., a battery of a smartphone or any other power storage device) by transmitting electric power from a vehicle power supply to the device power supply via an electromagnetic field in a non-contact manner. The first portion body 22a can be located between the charging unit 26 and the rechargeable device. Accordingly, the first portion body 22a can be thin enough to accommodate the electromagnetic field generated by the charging unit 26 to travel therethrough.

In various aspects, and with reference again to FIG. 1A, the charging unit 26 can be electrically coupled to a vehicle wire harness 50. For example, the vehicle wire harness 50 can be configured to direct electric power to a rear of the vehicle 10, for example to power rear-facing lights (e.g., brake lights, running lights, turn signal lights, etc.). In this regard, the charging unit 26 can be retrofitted into an existing vehicle. However, the vehicle wire harness 50 can be any suitable wire harness. In various aspects, the vehicle wire harness 50 can be a dedicated wire harness for the charging unit 26. The wire harness 50 can receive electric power from an onboard vehicle power source 52, such as a vehicle battery. Accordingly, the charging unit 26 can be powered by the onboard vehicle power source 52.

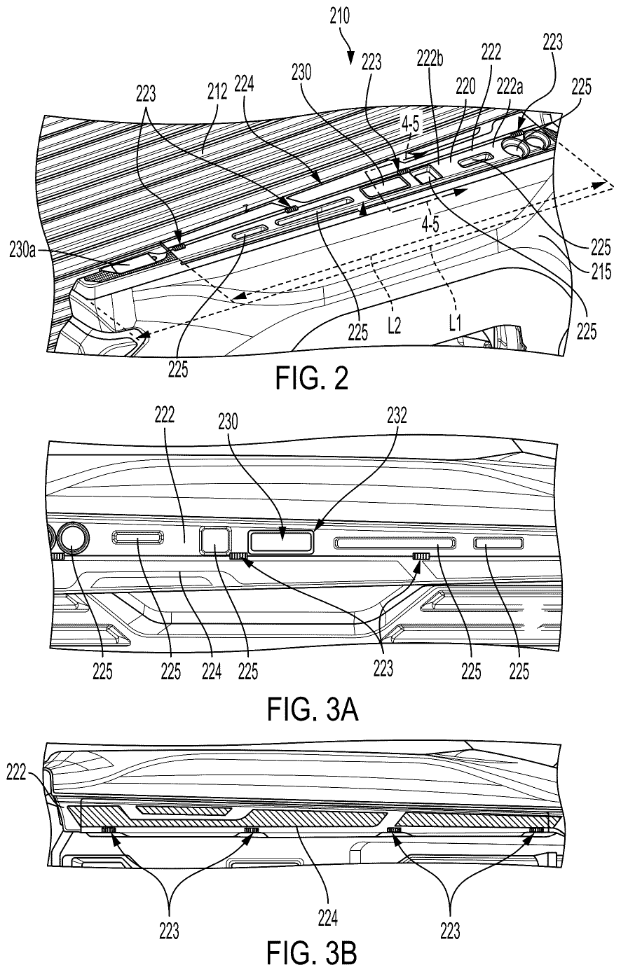

FIG. 2 is a perspective view of a covering 220 attached to a top or uppermost surface of a wall 215 of a cargo bed 212 of a vehicle 210. In various aspects, the covering 220 is similar to the covering 20 of FIG. 1 and FIG. 1A. The covering 220 can include a first portion 222 having a body 222a structured to be attached to the top surface of the wall 215. The first portion body 222a may have a first surface 222b.

The covering 220 may also include a second portion 224 rotatably connected to the first portion 222 at one or more rotatable connections 223. FIG. 3A and FIG. 3B are top views of the covering 220 attached to the top or uppermost surface of the wall 215 with the second portion 224 in a second orientation and a first orientation, respectively. In various aspects, a total length L1 of the first portion 222 can be greater than a total length of the second portion 224. The total length L2 can be between 50% and 99% of the total length L1, between 50% and 95% of the total length L1, between 50% and 90% of the total length L1, between 70% and 95% of the total length L1, or between 50% and 85% of the total length L1, in accordance with various aspects.

With combined reference to FIG. 2 through FIG. 3B, the first surface 222b can include a charging area 230 configured to receive a rechargeable device. The first surface 222b can include one or more cavities 225 spaced apart from the charging area 230 and configured to accommodate various items (e.g., tools, food, beverages, personal items, or any other item(s)). The second portion 224 can cover the cavities 225 when in the second orientation (e.g., see FIG. 3B). Although described herein in various aspects as being located at the surface that is covered by the second portion 224, the charging area can be located at a location of the first portion 222 that doesn't include the second portion 224, for example, see charging area 230a. In this manner, the charging area 230a can be accessible regardless of the orientation of the second portion 224.

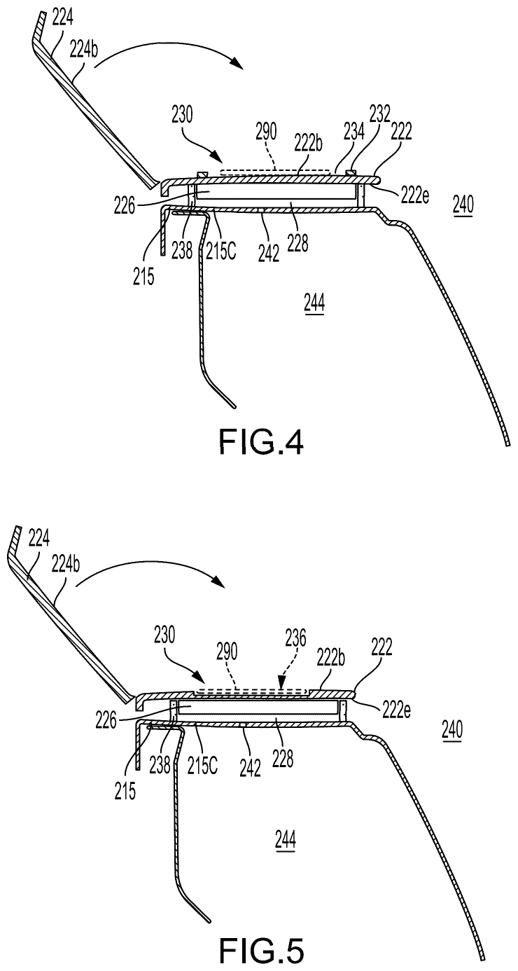

In various aspects, and with reference to FIG. 4, the charging area 230 can be at least partially delineated by a ridge 232 extending from the first surface 222b. The ridge 232 can be made of the same material as the first portion 222. The ridge 232 and the first portion 222 can be a single monolithic piece of material. In various aspects, the ridge 232 can form a seal around the charging area 230. For example, the first surface 224b of the second portion 224 can be configured to contact the ridge 232 when the second portion 224 is in the first orientation to enclose the charging area 230. In various aspects, the ridge 232 is made as a separate component from the first portion 222 and coupled to the first portion 222. For example, the ridge 232 can be formed as a soft plastic, rubber, or foam material configured to form a seal when the second portion 224 is in the first orientation. The ridge 232 can be formed as a weatherstripping. In various aspects the ridge 232 can be adhered to the first surface 222b.

In various aspects, the ridge 232 can define a cavity 234 sized and configured to accommodate a personal device 290 (e.g., a smart phone; also referred to herein as a rechargeable device). In various aspects, a depth of the cavity 234 can be configured to accommodate the personal device even when the second portion 224 is in the first orientation so that the second portion first surface 224b contacts the ridge 232 without the personal device blocking the second portion first surface 224b from contacting the ridge 232.

In various aspects, and with reference to FIG. 5, the charging area 230 can include a cavity 236 formed in the first portion first surface 222b. The cavity 236 can be formed as a depression in the first portion first surface 222b. In various aspects, the cavity 236 can be sized and configured to accommodate a personal device 290 (e.g., a smart phone; also referred to herein as a rechargeable device). In various aspects, a depth of the cavity 236 can be configured to accommodate the personal device even when the second portion 224 is in the first orientation so that the second portion first surface 224b contacts the first portion first surface 222b without the personal device blocking the second portion first surface 224b from contacting the first portion first surface 222b.

With combined reference to FIG. 4 and FIG. 5, a seal 238 can be provided to protect the charging unit 226 from debris (e.g., dust, moisture, etc.). The seal 238 can extend between and to the first portion second surface 222e and the top surface 215c of the wall 215. The seal 238 can surround the charging unit 226 to enclose the charging unit 226 within a charging unit cavity 228 from an ambient environment 240 (e.g., externally from the vehicle). The seal 238 can be configured to stop debris from contacting the charging unit 226. The seal 238 can be formed as a weatherstripping. The seal 238 can be made of a rubber, plastic, and/or foam material. In various aspects the seal 238 can be adhered to the first portion second surface 222e.

In various aspects, the top surface 215c of the wall 215 can include one or more cooling holes 242. The cooling hole 242 can provide a pathway for heat to escape the cavity 228. In various aspects, the cavity 228 can be in fluid communication with an interior chamber 244 of the wall 215 via the cooling hole 242. The cooling hole 242 can provide venting for the cavity 228 to any suitable location that provides cooling to the charging unit 226 while minimizing debris from entering the cavity 228.

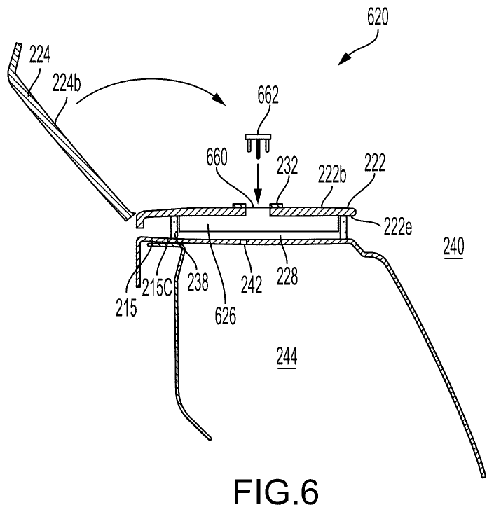

FIG. 6 shows a charging unit 626 having a power outlet 660 for charging the rechargeable device. With respect to FIG. 6, elements with like element numbering, as depicted in FIG. 4 and FIG. 5, are intended to be the same and will not necessarily be repeated for the sake of clarity. Although described herein in relationship to a non-contact charger, it is contemplated that the covering 620 can be equipped with a charger having a power outlet 660. The power outlet 660 can extend through the first portion 222 and be accessible from the first portion first surface 222b. The power outlet 660 may have openings for receiving an electrical plug. In this regard, the second portion 224 can provide a cover for the power outlet 660 when not in use to protect the power outlet 660 from debris/damage. Moreover, a removable cover 662 can be provided for further protecting the power outlet 660 when not in use. The cover 662 can be configured to be plugged into the power outlet 660 when not in use. The cover 662 can be made of a non-conductive material, such as plastic for example.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A covering for a wall of a vehicle cargo bed, the covering comprising:
a first portion structured to be attached to a top portion of the wall, the first portion having a first surface including a charging area configured to receive a rechargeable device and a second surface configured to face the top portion of the wall when the first portion is attached to the top portion of the wall;
a second portion rotatably connected to the first portion, the second portion having a first surface, the second portion being rotatable between a first orientation in which the second portion first surface resides directly opposite the first portion first surface and faces in a first direction toward the first portion first surface, and a second orientation in which the second portion first surface faces in a second direction opposite the first direction; and
a charging unit configured to be disposed between the top portion of the wall and the second surface directly beneath the charging area for charging the rechargeable device in response to the rechargeable device being placed on the charging area of the first surface.

2. The covering of claim 1, wherein the charging area includes a cavity formed in the first surface.

3. The covering of claim 1, wherein the charging area is at least partially delineated by a ridge extending from the first surface.

4. The covering of claim 1, further comprising a cavity disposed in the first portion, the cavity is spaced apart from the charging area, and the second portion is configured to cover the cavity in the first orientation.

5. The covering of claim 1, further comprising a seal disposed on the first portion first surface and surrounding the charging area, and the seal is configured to stop debris from entering the charging area and the second portion first surface is configured to contact the seal when the second portion is in the first orientation.

6. The covering of claim 1, further comprising a seal extending between and to the first portion second surface and the top portion of the wall and surrounding the charging unit to enclose a charging unit cavity from an ambient environment, and the seal is configured to stop debris from contacting the charging unit.

7. The covering of claim 1, wherein the second portion first surface is structured to be substantially coplanar with the first portion first surface when the second portion is in the second orientation.

8. The covering of claim 1, wherein the second portion first surface is flat, the first portion first surface is flat, and wherein the second portion first surface is structured to be substantially coplanar with the first portion first surface when the second portion is in the second orientation.

9. The covering of claim 1, wherein the charging unit is a non-contact charger.

10. A vehicle comprising:
a wall defining a portion of a cargo bed;
a covering mounted on a top portion of the wall, the covering including:
a first portion structured to be attached to the top portion of the wall, the first portion having a first surface including a charging area configured to receive a rechargeable device and a second surface configured to face the top portion of the wall when the first portion is attached to the top portion of the wall;
a second portion rotatably connected to the first portion, the second portion having a first surface, the second portion being rotatable between a first orientation in which the second portion first surface resides directly opposite the first portion first surface and faces in a first direction toward the first portion first surface, and a second orientation in which the second portion first surface faces in a second direction opposite the first direction; and
a charging unit disposed between the top portion of the wall and the second surface directly beneath the charging area for charging the rechargeable device in response to the rechargeable device being placed on the charging area of the first surface.

11. The vehicle of claim 10, wherein the charging area includes a cavity formed in the first surface.

12. The vehicle of claim 10, wherein the charging area is at least partially delineated by a ridge extending from the first surface.

13. The vehicle of claim 10, further comprising a cavity disposed in the first portion, the cavity is spaced apart from the charging area, and the second portion is configured to cover the cavity in the first orientation.

14. The vehicle of claim 10, further comprising a seal disposed on the first portion first surface and surrounding the charging area, and the seal is configured to stop debris from entering the charging area and the second portion first surface is configured to contact the seal when the second portion is in the first orientation.

15. The vehicle of claim 10, further comprising a seal extending between and to the first portion second surface and the top portion of the wall and surrounding the charging unit to enclose a charging unit cavity from an ambient environment, and the seal is configured to stop debris from contacting the charging unit.

16. The vehicle of claim 15, further comprising a cooling hole disposed in the top portion of the wall and in fluid communication with the charging unit cavity.

17. A vehicle comprising:
a wall defining a portion of a cargo bed;
a covering mounted on a top portion of the wall, the covering including a first portion structured to be attached to the top portion of the wall, the first portion having a first surface including a charging area configured to receive a rechargeable device and a second surface configured to face the top portion of the wall when the first portion is attached to the top portion of the wall; and
a charging unit configured to be disposed between the top portion of the wall and the second surface directly beneath the charging area for charging the rechargeable device in response to the rechargeable device being placed on the charging area of the first surface.

18. The vehicle of claim 17, wherein the charging unit is a non-contact charger.

19. The vehicle of claim 17, wherein at least one of:
the charging area includes a cavity formed in the first surface; or
the charging area is at least partially delineated by a ridge extending from the first surface.

20. The vehicle of claim 17, further comprising a seal extending between and to the first portion second surface and the top portion of the wall and surrounding the charging unit to enclose a charging unit cavity from an ambient environment, and the seal is configured to stop debris from contacting the charging unit.
